(19) United States
(12) Patent Application Publication
(10) Pub. No.: US 2018/0243970 A1
(43) Pub. Date: Aug. 30, 2018

(54) DEVICE AND METHOD FOR PATTERN IMPRINTING

(71) Applicant: Toshiba Kikai Kabushiki Kaisha, Tokyo (JP)

(72) Inventors: Mitsunori Kokubo, Numazu-shi (JP); Yuki Sugiura, Mishima-shi (JP); Shigeru Fujiwara, Numazu-shi (JP); Yuki Hashimoto, Numazu-shi (JP)

(73) Assignee: Toshiba Kikai Kabushiki Kaisha, Tokyo (JP)

(21) Appl. No.: 15/902,088

(22) Filed: Feb. 22, 2018

(30) Foreign Application Priority Data
Feb. 28, 2017 (JP) 2017-037028

(51) Int. Cl. B29C 59/04; B29C 35/08; B29C 59/00

(52) U.S. Cl. CPC B29C 59/046; B29C 2035/0827; B29C 59/002; B29C 35/0805

(57) ABSTRACT

A device for imprinting a mold onto resin laid on a substrate is comprised of an impression roller carrying the mold; a dancer roller to prevent the mold from loosening; a first driver configured to drive the impression roller; a second driver configured to drive the dancer roller; and a controller electrically connected to and configured to control the first driver and the second driver.

### CROSS-REFERENCE TO RELATED APPLICATIONS

This application is based upon and claims the benefit of priority from the prior Japanese Patent Application No. 2017-037028 (filed Feb. 28, 2017); the entire contents of which are incorporated herein by reference.

### BACKGROUND

### Technical Field

The disclosure herein relates to a device and method for imprinting a pattern of unevenness formed on an elongated flat sheet-like mold onto a light-sensitive chemical laid on a substrate to produce a macroscopic electronic device such as a touchscreen or a display screen.

### Description of the Related Art

A macroscopic electronic device such as a touchscreen or a display screen may he produced by a process similar to photolithography. In this process, a sheet-like mold having a pattern ranging throughout the touchscreen or the display screen is impressed on and detached from a resin laid on a. substrate to form a mirror-image pattern on the resin. The mold is in general discarded thereafter.

Japanese Patent Application Laid-open No. 2014-40070 discloses a related art, in which an elongated mold is fed from a feeder to a winder and the mold is impressed on a substrate in the course of feeding.

### SUMMARY

The art disclosed in the aforementioned reference may improve productivity but consumes a great-amount of molds. The device and the method disclosed herein have been created in view of this problem.

According to an aspect, a device for feeding a sheet-like mold with a pattern of unevenness from a feeder to a winder and imprinting the pattern onto a resin laid on a substrate, is comprised of: an impression roller carrying the mold and being movable in parallel with a surface of the substrate between a first position and a second position apart from the first position and so disposed as to impress the mold onto the substrate in response to a movement from the first position to the second position; a dancer roller guiding the mold toward the winder and being movable between a third position and a fourth position, the third position and the fourth position being respectively close to and away from the substrate in a direction perpendicular to the surface of the substrate; a first driver configured to drive the impression roller between the first position and the second position; a second driver configured to drive the dancer roller between the third position and the fourth position; and a controller electrically connected to and configured to control the first driver and the second driver, the controller being configured to execute a first control of the first driver to set the impression roller in motion from the first position to the second position to imprint the pattern onto the resin and of the second driver to move the dancer roller from the fourth position toward the third position in synchronous with the motion of the impression roller from the first position to the second position so as to prevent the mold from loosening.

According to another aspect, a method for feeding a sheet-like mold with a pattern of unevenness from a feeder to a Winder and imprinting the pattern onto a resin laid on a substrate, is comprised of: setting an impression roller carrying the mold in motion in parallel with a surface of the substrate from a first position to a second position apart from the first position so as to impress the mold onto the substrate in response to the motion; and moving a dancer roller for guiding the mold to the winder closer to the substrate in synchronous with the motion of the impression roller from the first position to the second position so as to prevent the mold from loosening.

### BRIEF DESCRIPTION OF THE DRAWINGS

FIG. 1A is a plan view of a product by pattern imprinting according to an embodiment.

FIG. 1B is a side view taken from an arrow IB in FIG. 1A.

FIG. 1C is a side sectional view taken from a line IC-IC in FIG. 1A.

FIG. 1D is an enlarged sectional view taken from an area ID in FIG. 10.

FIG. 2A is an enlarged plan view taken from an area IIA in FIG. 1A.

FIG. 2B is an enlarged plan view corresponding to FIG. 2A about an example.

FIG. 2C is an enlarged plan view corresponding to FIG. 2A about another example.

FIG. 2D is an enlarged plan view corresponding to FIG. 2A about still another example.

FIG. 3A is a plan view of a substrate with a mold attached thereon.

FIG. 3B s a side view taken from a line IIIB-IIIB in FIG. 3A.

FIG. 3C is an enlarged sectional view taken from an area IIIC in FIG. 3B.

FIG. 4A is a schematic plan view of the substrate and the mold with a mask unit laid thereon.

FIG. 4B is a schematic side view taken from a line IVB-IVB in FIG. 4A.

FIG. 4C is an enlarged sectional view taken from an area IVC in FIG. 4B.

FIG. 5A is a schematic plan view of the substrate after imprinting.

FIG. 5B is a schematic side view taken from a line VB-VB in FIG. 5A.

FIG. 5C is an enlarged sectional view taken from an area VC in FIG. SB.

FIG. 6 is a schematic elevational view of a device for pattern imprinting in accordance with an embodiment, in which an impression roller keeps the mold away from the substrate.

FIG. 7 is a schematic plan view of the device viewed from an arrow VII in FIG. 6.

FIG. 8 is a schematic side view of the device taken from a line VIII-VIII in FIG. 6.

FIG. 9 is a schematic side view of the device taken from a line IX-IX in FIG. 6.

FIG. 10 is a schematic side view of the device taken from a line X-X in FIG. 6.

FIG. 11 is a schematic elevational view of the device in a state where the impression roller moved so that the mold gets in face-to-face contact with the substrate.

FIG. 12 is a schematic elevational view of the device in a state where the mask unit is moved above the substrate with the mold laid thereon.

FIG. 13 is a schematic elevational view of the device in a state where the mask unit is pressed upon the substrate with the mold laid thereon and an ultraviolet ray source is before scanning.

FIG. 14 is a schematic elevational view of the device in a state where the mask unit is pressed upon the substrate with the mold laid thereon and an ultraviolet ray source is after scanning.

FIG. 15A is a schematic elevational view of the substrate with a resin laid thereon, the mold and the impression roller before moving the impression roller.

FIG. 15B is a schematic elevational view of the substrate with the resin laid thereon, the mold and the impression roller in the course of moving the impression roller.

FIG. 15C is a schematic elevational view of the substrate with the resin laid thereon, the mold and the impression roller after moving the impression roller, where the mold thoroughly gets in face-to-face contact with the resin on the substrate.

FIG. 16A is a schematic elevational view of the substrate with the resin where the resin has a thickened part at one end.

FIG. 16B is a schematic elevational view of the substrate with the resin where the substrate is partly left uncoated with the resin.

FIG. 16C is a schematic elevational view of the substrate with the resin where the resin has a thickened part aside from the one end.

FIG. 16D is a schematic elevational view of the substrate with the resin where the resin gets thicker toward one end.

FIG. 17A is a schematic plan view of the mask unit used in the device.

FIG. 17B is a schematic plan view of a mask unit in accordance with another embodiment.

FIG. 17C is a sectional view taken from a line XVIIC-XVIIC in FIG. 17B.

FIG. 17D is an enlarged sectional view taken from an area XVIID in FIG. 17C.

FIG. 18A is a schematic plan view of the substrate with the mask unit shown in FIG. 17B.

FIG. 18B is a schematic side view taken from a line XVIIIB-XVIIIB in FIG. 18A.

FIG. 18C is an enlarged sectional view taken from an area XVIIC in FIG. 18B.

FIG. 19 is a schematic plan view of a semi-product where imprinting is reciprocated so that a pattern is imprinted onto a plurality of areas on the substrate.

FIG. 20 is a schematic plan view of a semi-product having a plurality of areas being imprinted in accordance with another example.

FIG. 21A is a schematic elevational view of rollers through which the mold is threaded in accordance with modified embodiment where three dancer rollers are provided, in a state before the dancer rollers move.

FIG. 21B is a schematic elevational view of the rollers after the dancer rollers move.

FIG. 22 is a schematic plan view of a roller in accordance with another modified embodiment.

FIG. 23A is a schematic plan view of a mask unit with a mold, which is corresponding to FIGS. 3A and 4A.

FIG. 23B is a schematic side view taken from a line XXIIIB-XXIIIB in FIG. 23A.

FIG. 23C is an enlarged sectional view taken from an area XXIIIC in FIG. 23B.

### DESCRIPTION OF EMBODIMENTS

Certain embodiments will be described hereinafter with reference to the appended drawings. It is noted that these drawings are not always drawn to scale exactly and therefore dimensional relations among elements are not limited to those shown therein. Two-headed arrows X, Y and Z in some of these drawings respectively depict X-, Y- and Z-axes in the orthogonal coordinate system and are normally corresponding to longitudinal, lateral and vertical directions, whereas they are only for the convenience of explanation and therefore not limiting.

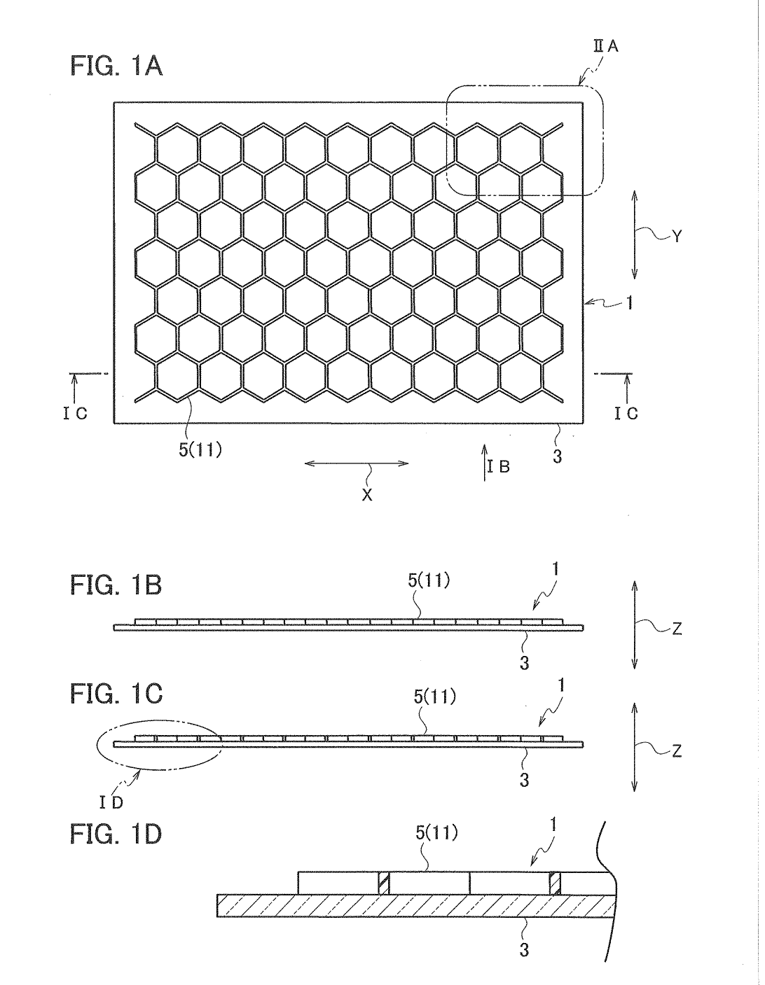

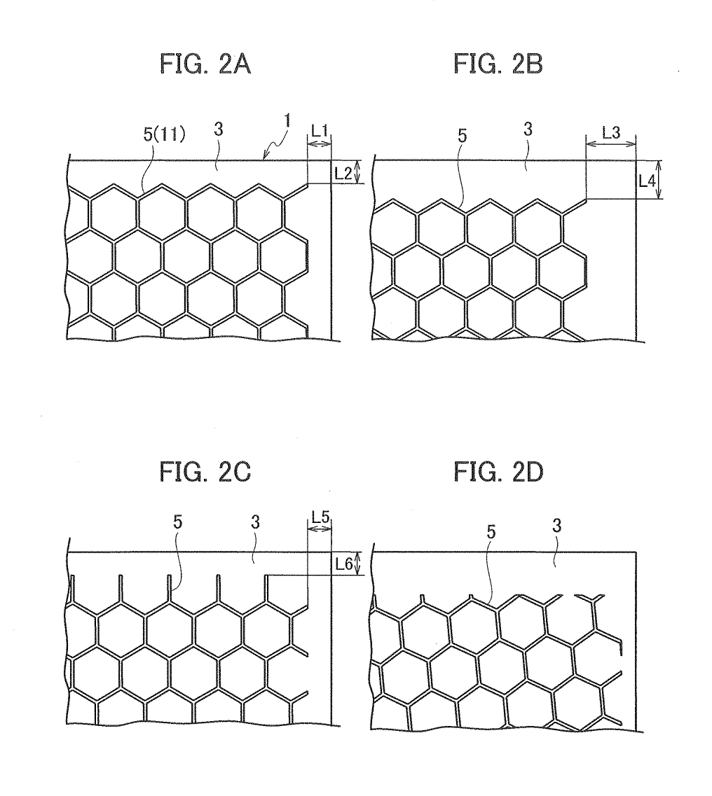

Referring mainly to FIGS. 1A through 1D and 2A through 2D, a product 1 by pattern imprinting is a filter applied to a screen or panel used for a touchscreen or a display screen of an LCD or OLED for example. The product 1 is in general provided with a substrate 3 and patterned protrusions 5 projecting therefrom.

The substrate 3 is a plate made of a transparent material such as glass or synthetic resin for example. The protrusions 5 are made from a curable resin that is cured when exposed proper electromagnetic wave, such as a photopolymer or light-activated resin sensitive to ultraviolet ray, and are formed by exposure to the electromagnetic wave. Further, the pattern of the protrusions 5 is resulted from the pattern imprinting in which a sheet-like mold 7 with a pattern 9 of unevenness is pressed upon the resin to form the protrusions 5 as a mirror-image of the pattern 9. The protrusions 5 are formed on one surface of the substrate 3. While FIG. 1A illustrates an example of the pattern of the protrusions in which walls form a honeycomb pattern, this is no more than an example and any arbitrary pattern can be applied thereto.

Disposition of the protrusions 5 relative to the substrate 3 may have some variations. FIG. 2A illustrates an example thereof, in which both distances L1 and L2 from a corner of the pattern to longitudinal and lateral edges of the product 1 are equal. If both L1 and L2 are within a tolerable range, it may be an acceptable product.

FIG. 2B illustrates another example, in which one or more distances L3 and L4 are beyond an upper limit (L3>L1; L4>L2). FIG. 2C illustrates still another example, in which one or more distances L5 and L6 are below a lower limit (L5<L1; L6>L2). FIG. 2D illustrates a distinct example, in which the pattern is oblique. These examples may be often qualified as inferior products.

The product 1 is generally produced by pattern imprinting in a way as described below.

The substrate 3 is for example a thin sheet with an elongated rectangular shape, and is supported in direction where its surface faces upward in the vertical direction (Z-axis).

First a resin 11 is laid on a surface of the substrate 3, which is still uncured, namely viscous, but curable when exposed to proper electromagnetic wave (ultraviolet ray in this example). The resin 11 may form a thin film on the surface, or throughout the surface for example. This step of resin layer formation results in formation of the layer of the resin 11 on the substrate 3.

The mold 7 is generally an elongated flat sheet, or an elongated tape or band, and has the pattern 9 at least on its lower surface. The entirety of the mold 7 along with the pattern 9 may be formed of a material transparent to the ultraviolet ray. This is served for the process in a way that the mold 7 is rolled as a stock roll 25 set on a feeder 67 and is threaded from the feeder 67 to a winder 69 in an imprinting device described later.

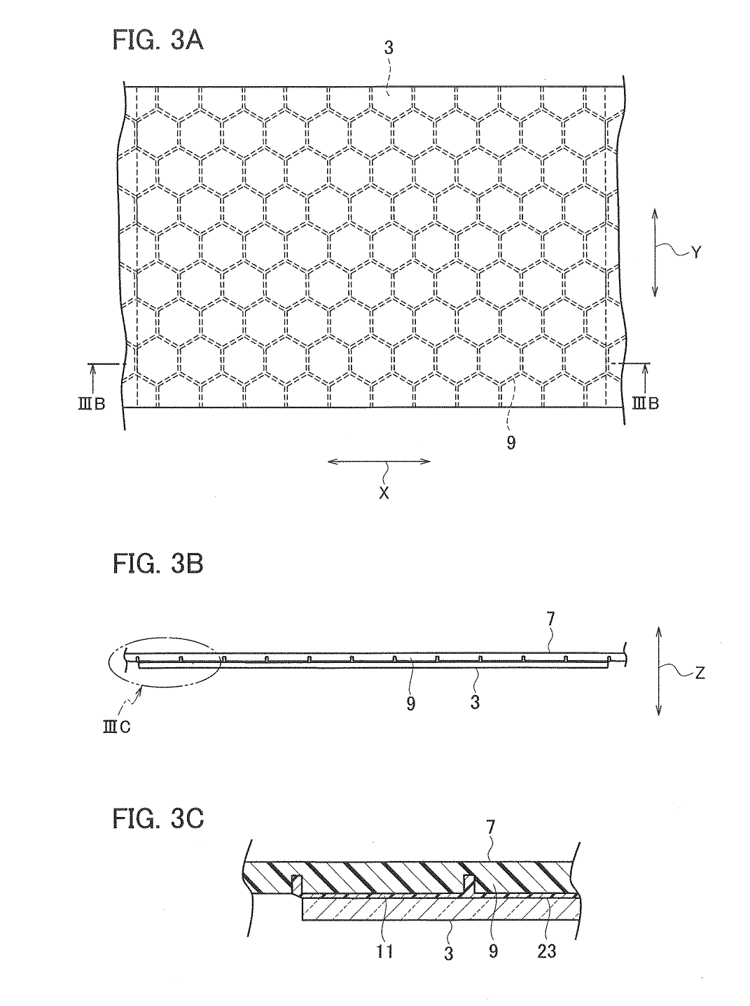

The pattern 9 on the mold 7 is made in face-to-face contact with, or pressed onto, the resin 11 on the substrate 3. In this state, the mold 7 comes above the substrate 3 in the vertical direction (Z-axis) and the pattern 9 wedges into the resin 11 as illustrated in FIG. 3C for example, as the resin 11 is still uncured and thus viscous.

In this step, the mold 7 is preferably aligned with the substrate 3 in the longitudinal and lateral directions (X-, Y-axes) and also around the vertical axis (Z-axis).

This step of impression causes imprint of the pattern 9 onto the resin 11 so that a mirror-image of the pattern 9 is formed in the resin 11.

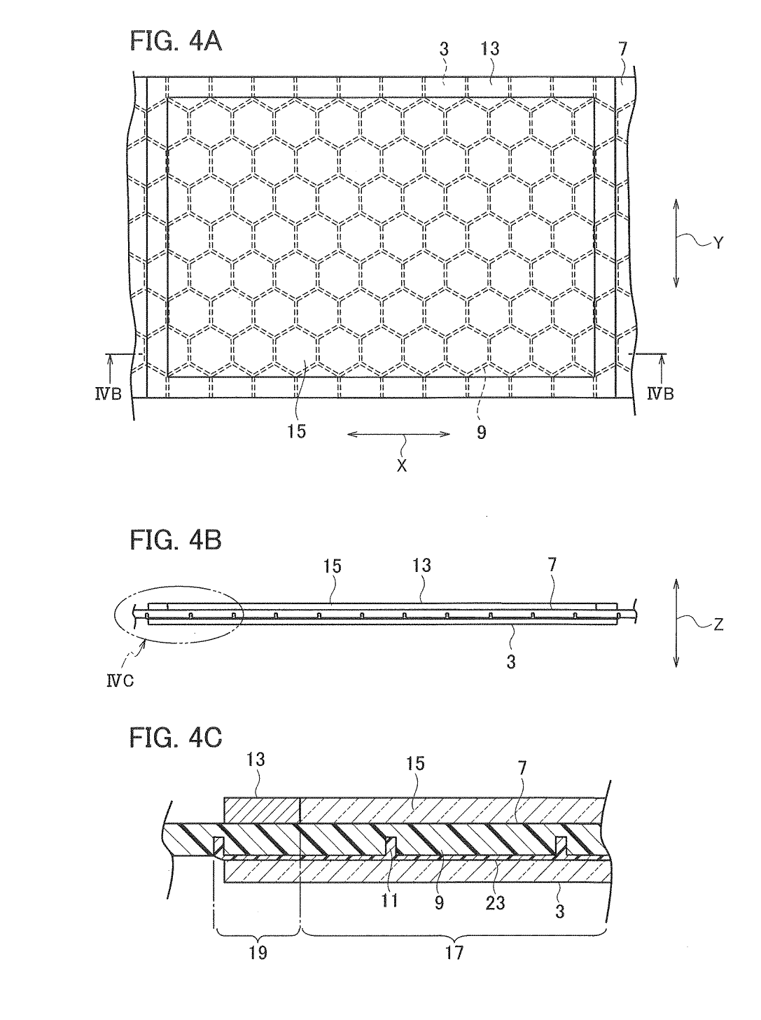

Next, with keeping the mold 7 in contact with the substrate 3, a mask unit 13 is moved above and aligned with the mold 7 and the substrate 3 as shown in FIG. 4 (a step of mask unit alignment).

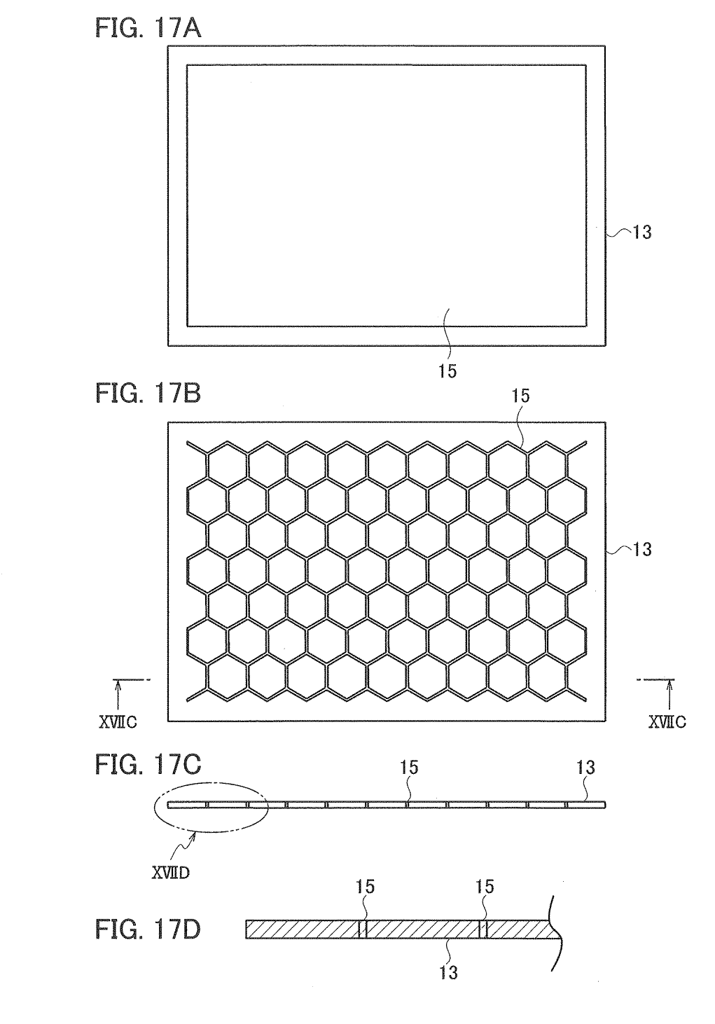

The mask unit 13 is a relatively thin framework and has a window section 19 which is an open window or covered with a film or bulk transparent to the ultraviolet ray (see FIG. 17A in combination). The mask unit 13 may have plural window sections 15. Aside from the window section(s) 15, the mask unit 13 may be opaque to the ultraviolet ray.

In the step of mask unit alignment, the mold 7, the substrate 3 and the mask unit 13 are totally aligned with each other in the longitudinal and lateral directions (X-, Y-axes) and also around the vertical axis (Z-axis).

The resin 11 on the substrate 3 is exposed to the ultraviolet ray applied through the window section(s) 15 of the mask unit 13 and the mold 7 (a step of exposure).

In the step of exposure, the mold 17 may be slightly or considerably pressed down onto the substrate 3 by means of the mask unit 13.

In the step of exposure, the ultraviolet ray passes through the window section(s) 15 of the mask unit 13 and next through the mold 7 and is then applied to the curable resin 11. This exposure lasts until the resin 11 in exposed areas gets thoroughly cured.

As a result of the step of exposure, in the resin, the areas exposed to the ultraviolet ray (17 in FIG. 4C) are cured but the remaining areas masked with the mask unit 13 (19 in FIG. 4C) are left uncured.

After the step of exposure, the mask unit 13 is displaced (a step of displacement) and the mold 7 is detached from the substrate 3 and the resin 11 thereon (a step of detachment). After the step of detachment, the uncured resin is removed (a step of removal).

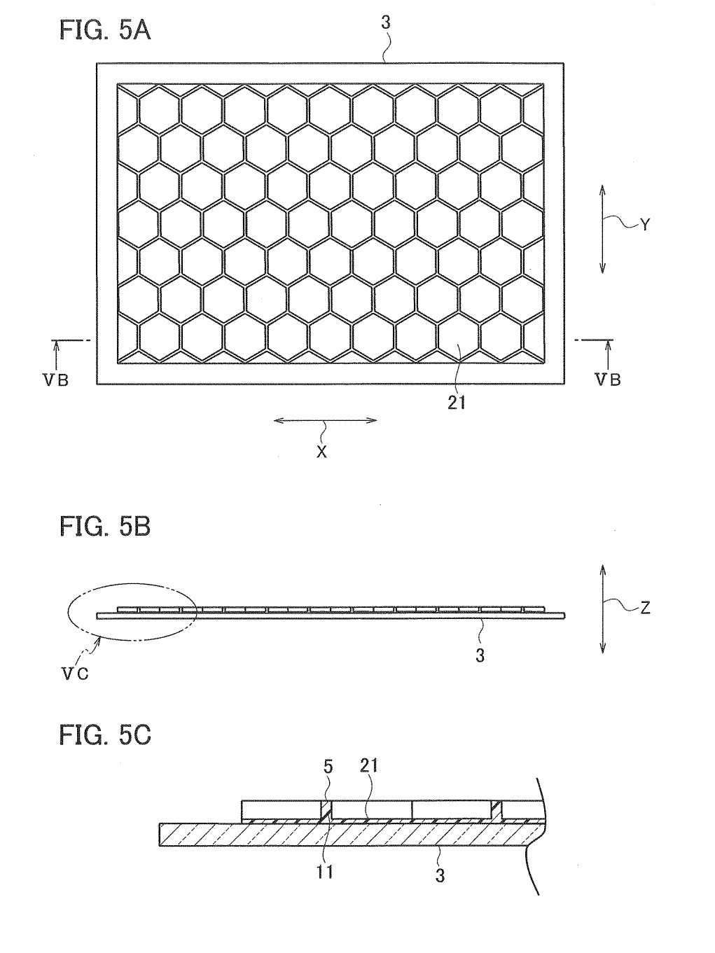

Portions of the resin 11 squeezed into dents in the pattern 9 (see FIG. 3C for example) before curing come to be the protrusions 5 after the step of removal, as will be understood from FIG. 5C. Remaining portions 23 of the resin 11 may be left in gaps between mold 7 and the substrate 3 and may come to be residual portions 21, as portions lower than the protrusions 5, even after the step of removal.

These residual portions 21 may be removed by any known method, such as O₂ ashing (a step of removing residual portions). Then the product such as that shown in FIG. 1 can be produced. The pattern of the protrusions 5 is, as described above, a mirror-image and also a complementary pattern of the pattern 9 on the mold 7.

The pattern of the protrusions 5 as the mirror-image of the pattern 9 is formed within an area on the substrate, which was originally under the window section 15 of the mask unit 13.

The production method will be described in more detail hereafter. Where the substrate 3 in the step of impression is viewed from above, the substrate 3 is partly or totally covered with the area where the pattern 9 is formed on the mold 7. Where the substrate 3 in the step of mask unit alignment is viewed from above, this area ranges within or throughout the window section(s) 15 of the mask unit 13.

One example of such embodiments is illustrated in FIG. 4A, in which the mask unit 13 has only one single window section 15 at its center and the pattern 9 formed on the mold 7 ranges throughout the window section 15.

The mold 7 is, as described already, formed as an elongated flat sheet, or an elongated tape or band, and wound around the bobbin set on the feeder 67. One end of the mold 7 is led out of the feeder 67 and threaded through some intermediate rollers to the winder 69.

Some of the rollers, in the step of impression, move so as to carry the mold 7 in part above the substrate 3 and impress the pattern 9 on the resin 11 without loosening the mold 7.

The window section 15 may not be necessarily in a rectangular shape as shown in FIGS. 4A and 17A but a variety of shapes are applicable thereto. As in an example shown in FIGS. 17B, 17C and 17D, the window section 15 may be in a shape matching the pattern 9 on the mold 7.

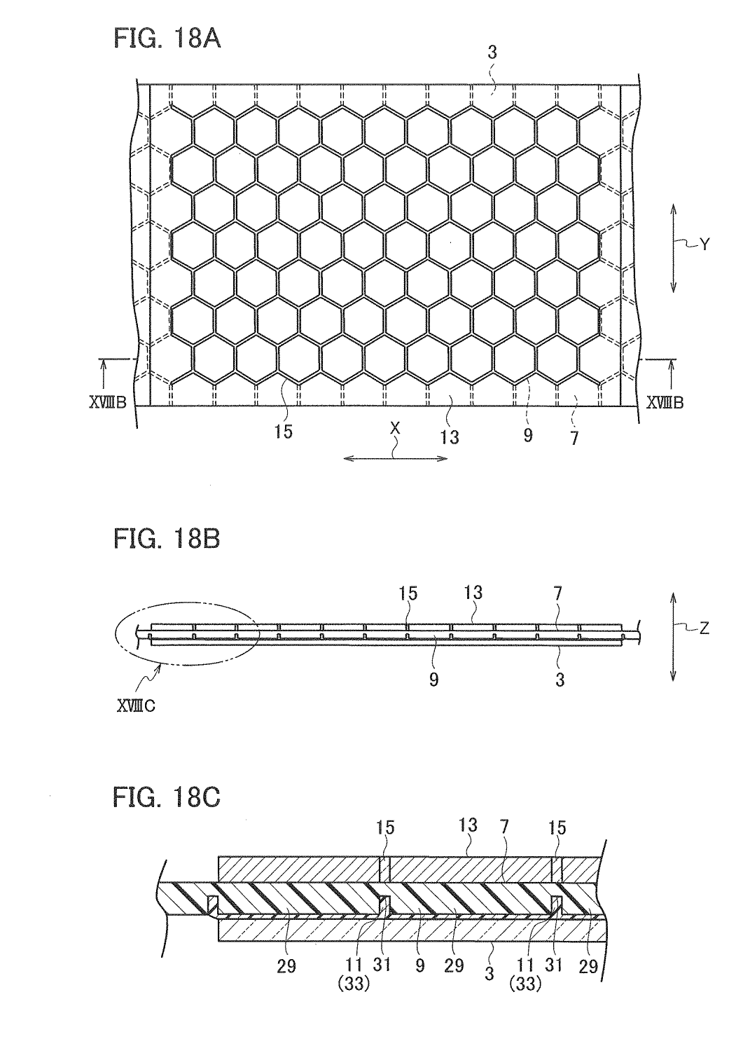

Further, the mask unit 13 and the mold 7 may be aligned together as shown in FIGS. 18A through 18C so that the window section 15 and the pattern 9 match with each other.

Details thereof will be explained hereafter.

The pattern 9 on the mold 7 is, as shown in FIG. 18C, comprised of lands 29 that are relatively projecting and grooves 31 that are indented therefrom. Even in the step of impression, minute gaps may be held between the lands 29 and the substrate 3 and a very little amount of uncured resin 11 may be left in these gaps. Of course, if the lands 29 could closely contact with the substrate 3, there might not be any left resin 11 aside from the grooves 31.

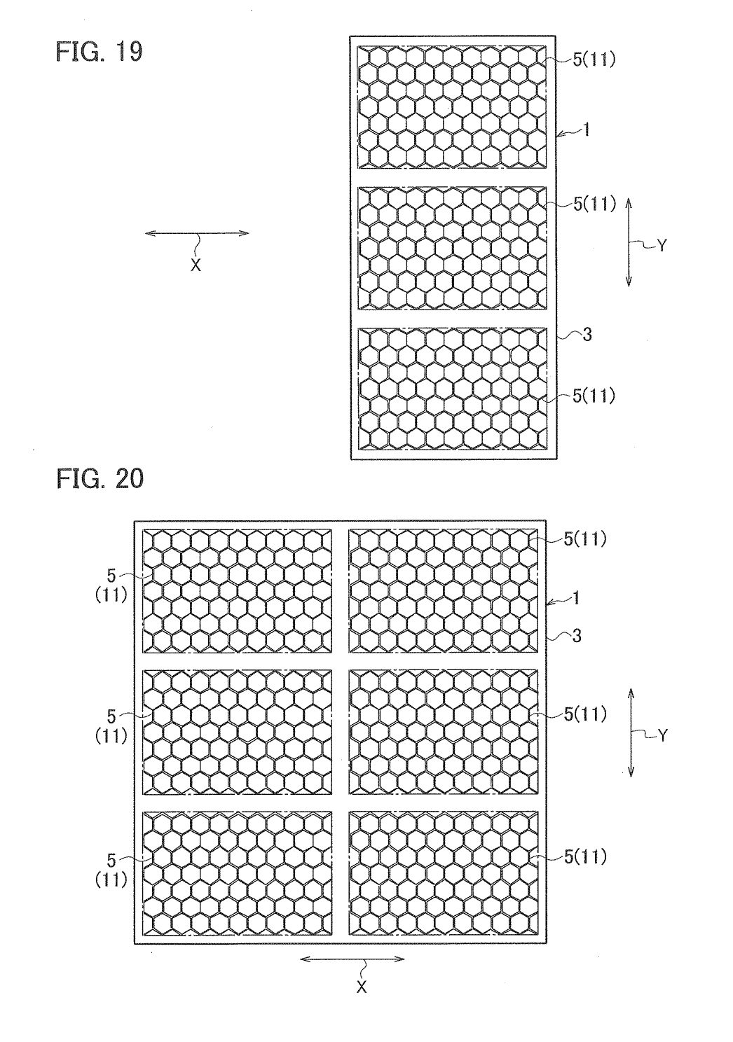

In contrast, between the grooves 31 and the substrate, there are spaces 33 and the uncured resin 11 fills these spaces 33.

Where the mask unit 13 in the step of mask unit alignment is viewed from above, as shown in FIG. 19A, the window section 15 of the mask unit 13 overlaps with the lands 29 of the mold 7, and any portions of the mask unit 13 aside from the window section 15 overlap with the grooves 31 of the mold 7.

Ultraviolet ray passes through the window section 15 of the mask unit 13 and the grooves 31 of the mold 7 and reaches the uncured resin 11 filled in the spaces 33. Then the resin 11 in the spaces 33 becomes the projections 5 in the product 1 and the resin 11 aside from these portions is left uncured.

The mold 7 is thereafter detached from the substrate 3 and the uncured resin 11 can be readily removed. Thus the product 1 without residual portions 21 can be readily provided.

Execution of the step of impression is not limited to only once but may be reciprocated. Such a modification facilitates formation of a repeating pattern of projections 5 on a substrate 3 as shown in FIGS. 19 and 20 for example. Alternatively, repeating patterns 9 may be formed on a mold 7. This modification provides a similar result. Adjacent patterns 9 may be either identical or distinct.

Specifically, the substrate 3 may be broadened or extended into a whole-number multiple of an area of the pattern 9 or further slightly broader, or the substrate 3 may be narrowed or shrunk. If the step of impression is reciprocally executed with moving a part where the mold 7 impressed onto the substrate 3, an imprinted pattern with a repeating or non-repeating pattern can be formed.

The method of imprinting as described above may be executed by an imprinting device 41, which will be described hereafter.

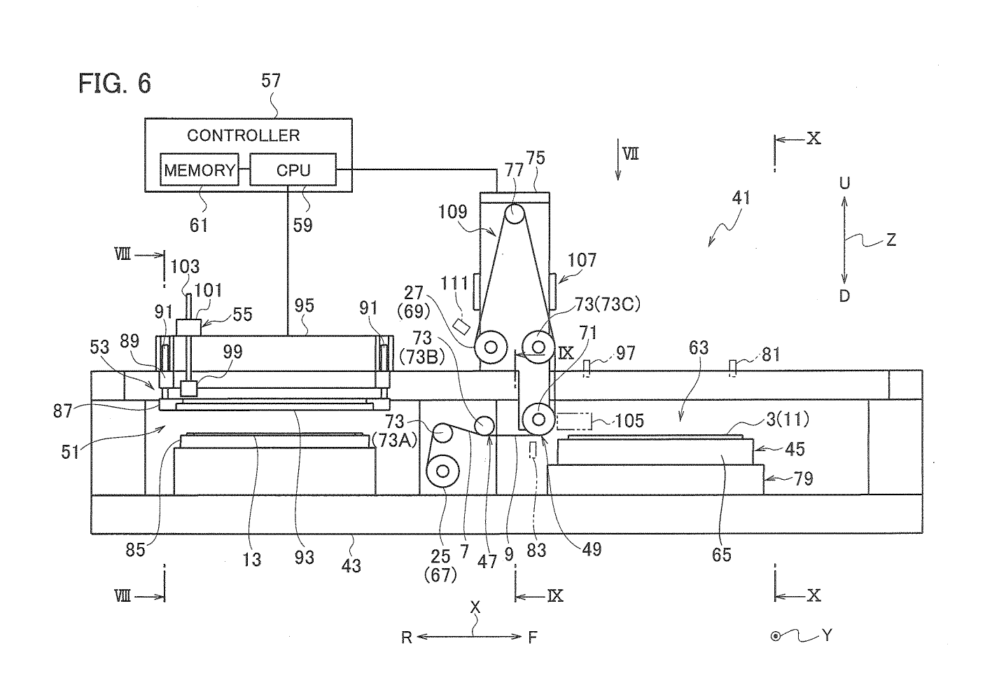

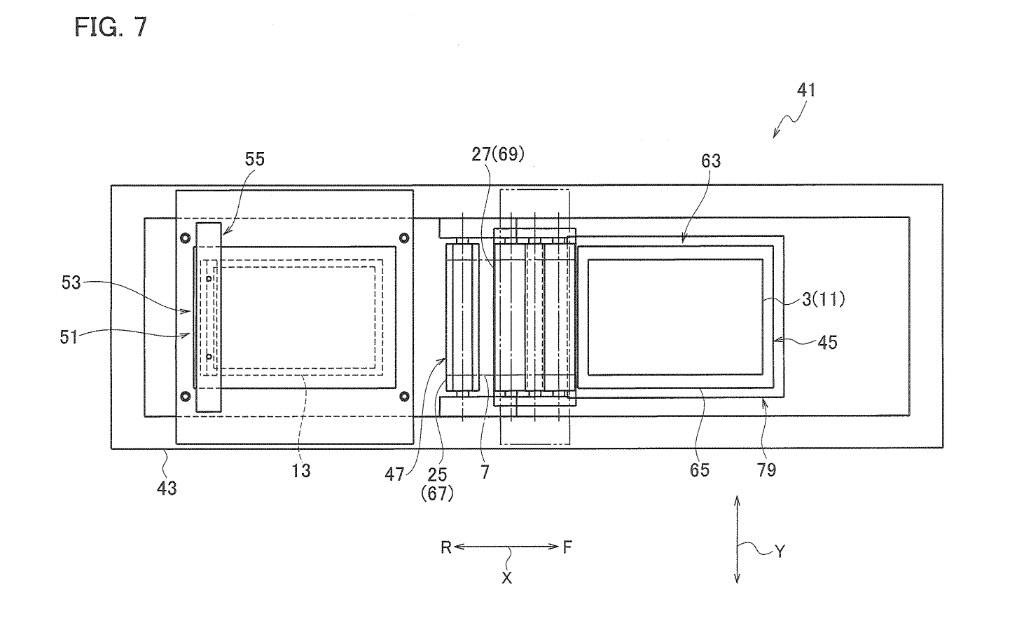

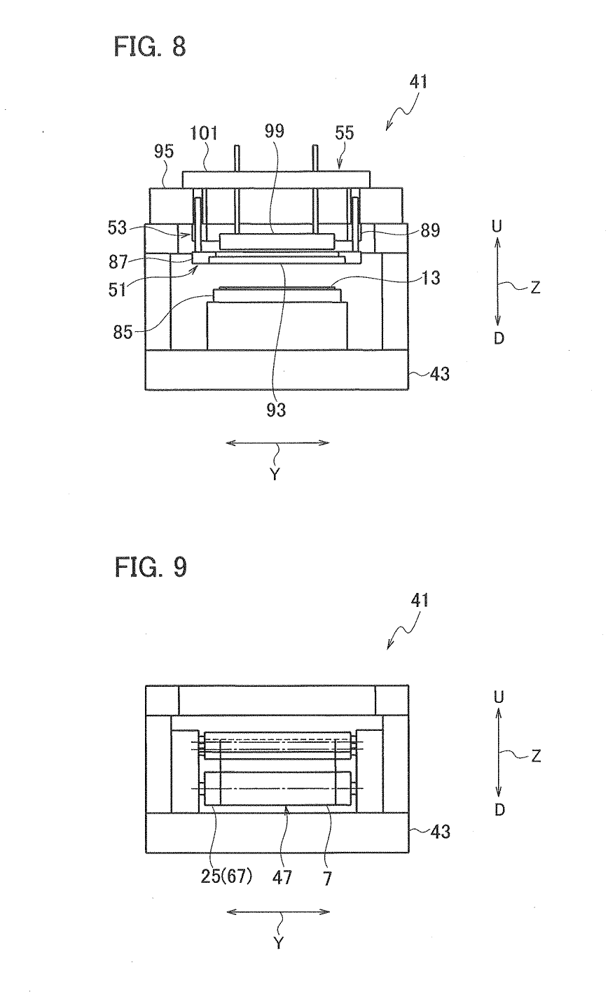

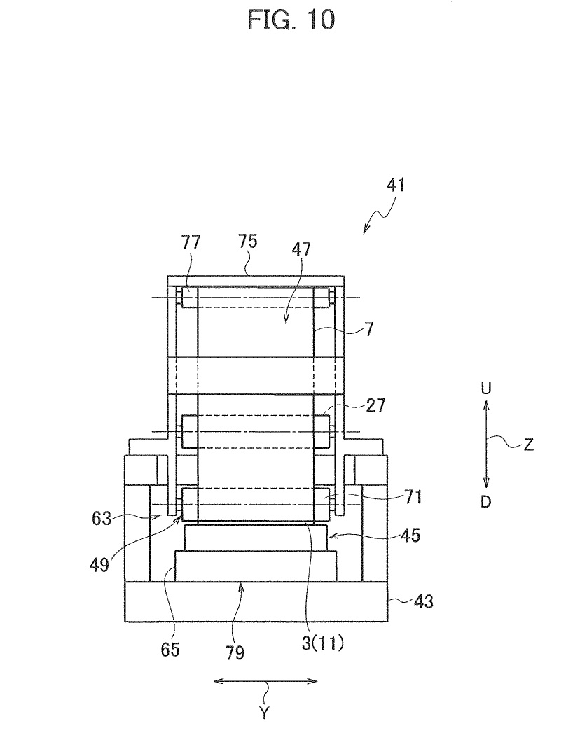

The imprinting device 41 is, as shown in FIGS. 6-10, generally provided with a base body 43, a substrate bed 45, a mold holder 47, a mold imprinter 49, a mask support 51, mask locater 53, a UV applicator 55 and a controller 57.

The substrate bed 45 may be mounted on the base body 43 and has a structure adapted for holding the substrate 3 of a flat plate-like form laid thereon. The substrate 3 has the Liv curable resin 11, as a thin coating in an uncured state, on at least some part of or throughout its upper surface. The substrate bed 45 may be so structured as to be movable in either or both of the directions of the X-, Y-axes under control by the controller 57.

The mold holder 47 may also be mounted on the base body 43 and has a structure adapted for holding the mold on which the pattern 9 is formed.

The mold imprinter 49 may also be mounted on the base body 43 and is so structured as to carry and impress the mold 7 onto the uncured resin 11 on the substrate 3, which is laid on the substrate bed 45.

While the mold holder 47 and the mold imprinter 49 are provided with a plurality of rollers through which the elongated mold 7 is threaded, its details will be described later.

The mold 7 is so held by the mold holder 47 and the mold imprinter 49 as to expose the surface having the pattern 9 downward, specifically toward the substrate 3.

The mask support 51, which may also be mounted on the base body 43, has a structure adapted for supporting the mask unit 13 laid thereon.

The mask locater 53, which may also be mounted on the base 43, is so structured as to locate the mask unit 13 above the substrate 3 and the mold 7 thereon.

The UV applicator 55, which may also be mounted on the base body 43, is to apply the ultraviolet ray to the curable resin 11 on the substrate 3 that is laid on the substrate bed 45. The UV applicator 55 is so disposed as to apply the ultraviolet ray through the window section 15 of the mask unit 13 located by the mask locator 51 and the mold 7 carried by the mold imprinter 49 on the substrate 3 to the resin 11.

The imprinting device 41 may be further provided with a substrate/mold alignment section 63, which may also be mounted on the base body 43. The substrate/mold alignment section 63 is so structured as to align the substrate 3 laid on the substrate bed 45 with the mold 7 held by the mold holder 47.

The controller 57 is provided with a CPU 59 and a memory 61 storing a program for operating the CPU 59. The controller 57 is electrically connected at least to the mold imprinter 49, the mask locater 53, and the UV applicator 55 and thus controls these elements.

The controller 57 is so programmed as to execute the following control over the mold imprinter 49, the mask locater 53, and the UV applicator 55.

In advance of the step of imprinting, the controller 57 controls the mold imprinter 49 to move the mold 7 so that the mold 7 is aligned with the substrate 3 in the longitudinal and lateral directions (X-, Y-axes) and also around the vertical axis (Z-axis).

Next the controller 57 controls the mold imprinter 49 to press the mold 7 onto the substrate 3 (specifically, onto the uncured resin 11). In parallel or subsequently, the controller 57 controls the mask locater 53 to move the mask unit 13 so that the mask unit 13 is aligned with the substrate 3 and the mold 7. In a case where the window section 15 of the mask unit 13 is in a shape that matches the pattern 9 on the mold 7, the controller 57 controls the mask locater 53 to accurately align the window section 15 with the pattern 9.

Subsequently, the controller 57 operates the if applicator 55 to apply ultraviolet ray to the resin 11 on the substrate 3 laid on the substrate bed 45.

Subsequently, the controller 57 controls the mold imprinter 49 to detach the mold 7 from the substrate (specifically, from the cured resin 11).

The controller 57 may be so programmed as to reciprocate the aforementioned control with moving a part where the mold impressed onto the substrate 3 as described above and shown in FIGS. 19 and 20.

Specifically, if the controller 57 detects that the substrate 3 is on the substrate bed 45, the mold 7 is held by the mold holder 47, and the mask unit 13 is held by the mask support 51, the controller 57 execute the following control.

The controller 57 controls the substrate bed 45 to move the substrate 3 in one location and then executes the aforementioned steps of impression, mask unit alignment, exposure, displacement and detachment. Subsequently the controller 57 controls the substrate bed 45 again to move the substrate 3 in another location and then executes these steps. These steps are reciprocated in a predetermined number. Then the repeating pattern as illustrated in FIGS. 19 and 20 is formed on the substrate 3.

Referring to FIGS. 6-10, the imprinting device 41 will be described hereafter in more detail.

The imprinting device 41 is, as described already, generally provided with the base body 43, the substrate bed 45, the mold holder 47, the mold imprinter 49, the mask support 51, the mask locater 53, the UV applicator 55 and the controller 57.

The substrate bed 45 is provided with a pedestal 65 that has a flat upper face where the substrate 3 is laid. The pedestal 65 may be further provided with a vacuum block for sucking and holding the substrate 3.

The imprinting device 41, or any external device, may be provided with a conveyor or a robot for carrying the substrate 3 in and out of the substrate bed 45 although not shown in the drawings. The conveyor or the robot may make the substrate 3 be aligned with the pedestal 65 prior to the subsequent steps.

The mold holder 47 is, as described already, provided with the feeder 67 holding the stock roll 25 and the winder 69. The mold 7 is led out of the stock roll 25 set on the feeder 67 and wound by the winder 69 into a payout roll 27. In this midway, the mold 7 is threaded around the mold imprinter 49 without loosening.

The mold imprinter 49 is provided with a roller support 75, which is provided with and supports a plurality of guiding rollers 73 (73A, 73B, 73C, in this example), a dancer roller 77 and an impression roller 71 among the rollers 73 and 77. These rollers may be cylinders rotatable about these axes which are elongated in the Y-axis, but not limited thereto.

The guiding rollers 73A and 73B may be disposed upstream relative to the impression roller 71 and the guiding roller 73C may be disposed downstream.

The mold 7 is, from the feeder 67 to the winder 69, threaded first around the guiding rollers 73A and 73B, next around the impression roller 71, next around the guiding roller 73 and finally around the dancer roller 77 for example. The dancer roller 77 is made movable in order to prevent the mold 7 from loosening. Details will be described later.

The roller support 75 is movably supported by the base body 43 in a way as to be movable in the direction along the X-axis. To drive the roller support 75 in the X-axis, the imprinting device 41 may be provided with an actuator 107 having a linear motor or such driving means.

The roller support 75 carries the impression roller 71, the guiding roller 73C, dancer roller 77, and the winder 69 in the direction along the X-axis.

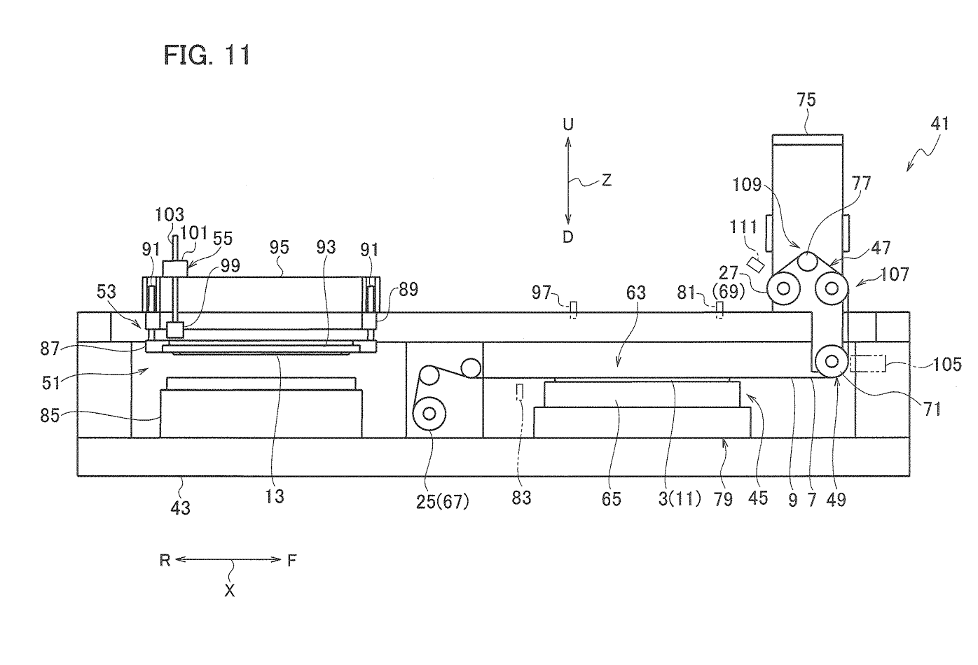

The mold 7 runs around the periphery of the impression roller 71. Thus the impression roller 71 carries the mold 7 from a first position (shown in FIG. 6) to a second position (shown in FIG. 11) apart from the first position. In the first position, the impression roller 71 keeps the mold 7 away from the substrate 3. When the impression roller 71 moves in parallel with the surface of the substrate 3 from the first position to the second position, in response, the mold 7 is impressed onto the resin 11 on the substrate 3.

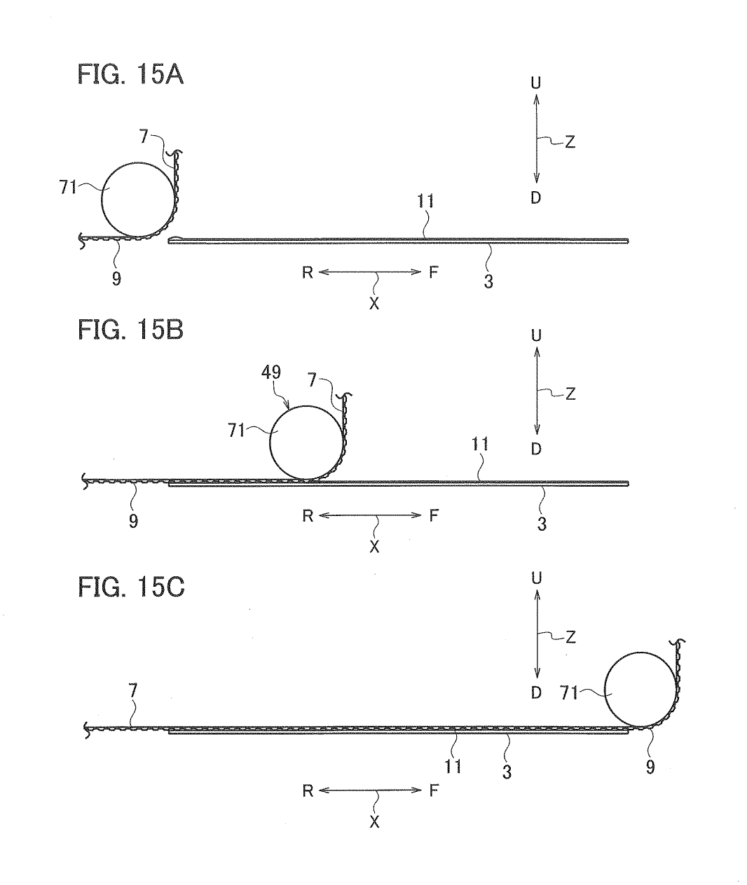

These elements may be so structured that the contact area between the mold 7 and the resin 11 gradually broadened from one end to another end of the resin 11 as the impression roller 9 goes from the first position to the second position (as shown by the reference signs R to F in FIGS. 15A through 15C).

After finishing the motion to the second position, the mold 7 runs in parallel with the substrate 3 with having the resin 11 interposed therebetween at least where the mold 7 gets in face-to-face contact with the resin 11 as shown in FIG. 3B.

In contrast, when the impression roller 71 moves back to the first position, the mold 7 gets detached from the resin 11.

The substrate/mold alignment section 63 is provided with a bed support 79, a first detector 81 and a second detector 83.

The first and second detectors 81, 83 may be any image sensors or cameras and may be electrically connected to the controller 57. They may be fixed to the base body 43 or any stationary entity.

The first detector 81 detects the position of the substrate 3. In one example, alignment marks are attached to the substrate 3 and the first detector 81 continuously takes images of the moving alignment marks, thereby detecting the position of the substrate 3. Detected data are sent to the controller 57 and used for control executed thereby.

Instead of the alignment marks, edges of or any substances on the substrate 3 may be used for detecting the position.

The second detector 83 detects the position of the mold 7. In one example, alignment marks are attached to the mold 7 and the second detector 83 continuously takes images of the moving alignment marks, thereby detecting the position of the mold 7. Instead of the alignment marks, edges of the mold 7, any part of the pattern 9, or any substances on the mold 7 may be used for detecting the position. Detected data are sent to the controller 57 and used for control executed thereby.

The bed support 79 carries the substrate bed 65 and may be provided with actuators for moving the substrate bed 65 in the longitudinal and lateral directions (X-, Y-axes) and also around the vertical axis (Z-axis), thereby enabling alignment of the substrate 3. The actuators may be servomotors, linear motors or such and are electrically connected to the controller 57.

The mask support 51 is provided with a mask bed 85 and a mask catcher 87. The mask bed 35 has a plain upper surface on which the mask unit 13 can be laid. In contrast, the mask catcher 87 has a generally plain lower surface adapted for catching the mask unit 13.

The mask catcher 87 is supported by and hung down from supports 59 respectively secured to the mask locates 53 and, between the mask catcher 87 and the supports 89, guiding rods 91 may be interposed. Each support 89 may have an actuator or a pneumatic or hydraulic cylinder to drive the guiding rod 91 in the vertical direction. Thereby the device is capable of controllably moving down and up the mask catcher 87 toward and from the mask bed 85.

The mask catcher 87 is provided with means for catching the mask unit 13, such as movable detents or a vacuum block.

The controller 57, when the mask unit 13 is laid on the mask bed 85, controls the mask support 51 to move down the mask catcher 87 and further controls the mask catcher to catch the mask unit 13. Next, the controller 57 controls the mask support 51 to move up the mask catcher 87, then the mask unit 13 gets apart from the mask bed 85 as shown in FIG. 11.

The mask catcher 87 is provided with a window 93 for allowing ultraviolet ray generated by the UV applicator 55 to pass through the window 93 to the resin 11 located below. The window 93 may be an open window or filled with a glass or such a material transparent to ultraviolet ray.

The mask locater 53 is provided with the supports 89, a carrier 95 and a third detector 97.

The third detector 97 may be, as with the first and second detectors 81, 83, any image sensor or a camera electrically connected to the controller 57 and may be fixed to the base body 43 or any stationary entity. The third detector 97 is so disposed as to continuously take images of the moving mask unit 13 caught and carried by the mask catcher 87.

In one example, alignment marks are attached to the mask unit 13 and the third detector 97 continuously takes images of the moving mask unit 13 and sends detected data to the controller 57 so that the controller 57 can determine the position of the mask unit 13. Instead of the alignment marks, edges of any substances on the mask unit 13 may be used for detecting the position.

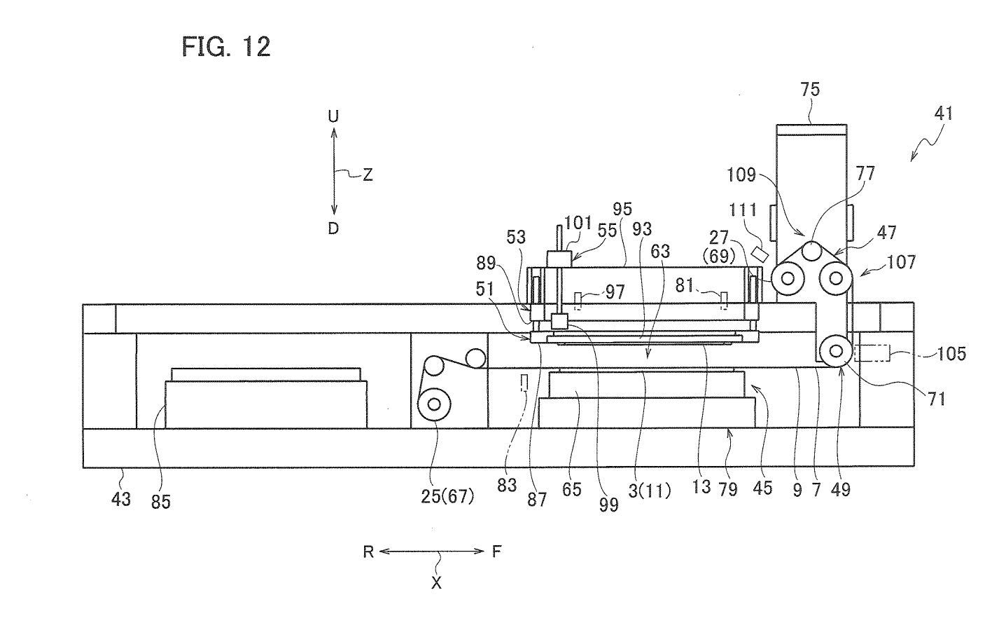

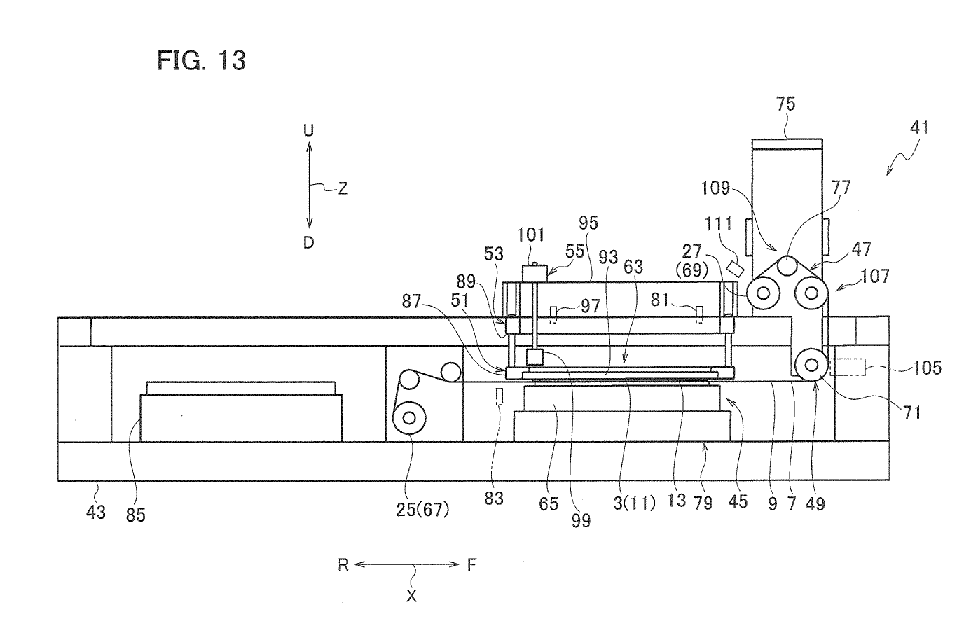

The carrier 95 is supported by the base body 43 in a way as to be movable in the direction along the X-axis between a waiting position as illustrated in FIG. 6 and a workable position as illustrated in FIGS. 12 and 13. The device may have a linear motor or such driving means to move the carrier 95.

The supports 89 are supported by the carrier 95 and movable in the longitudinal and lateral directions (X-, Y-axes) and also around the vertical axis (Z-axis) as being driven by any driving means such as a motor, thereby being aligned with the carrier 95.

The controller 57 receives image data from the detector 81 and/or the detector 83 and further from the detector 97, thereby calculates a travel distance and an orientation of the mask catcher 87, and drives the mask locater 53 in accordance with the calculation results. Alternatively or additionally, the controller 57 may execute feedback control on the basis of continuously receiving image data. Thereby the mask unit 13 is aligned with the substrate 3 or the mold 7.

When the mask catcher 87 is to be aligned with the mask locater 95 (when the mask unit 13 is to be aligned with the substrate 3 or the mold 7), the mask locates 95 is at the workable position shown in FIGS. 12 and 13 and therefore the mask locater 95, the mask catcher 87 and the mask unit 13 are positioned substantially just above the substrate 3 laid on the pedestal 55.

The UV applicator 55 is provided with a UV generator 99 and a generator support 101. The generator support 101 supports the UV generator 99 via a guide rod 103 and such and allows the UV generator 99 moving in the vertical direction along the X-axis. The generator support 101 may be provided with a pneumatic or hydraulic cylinder or such actuator means for moving the UV generator 99.

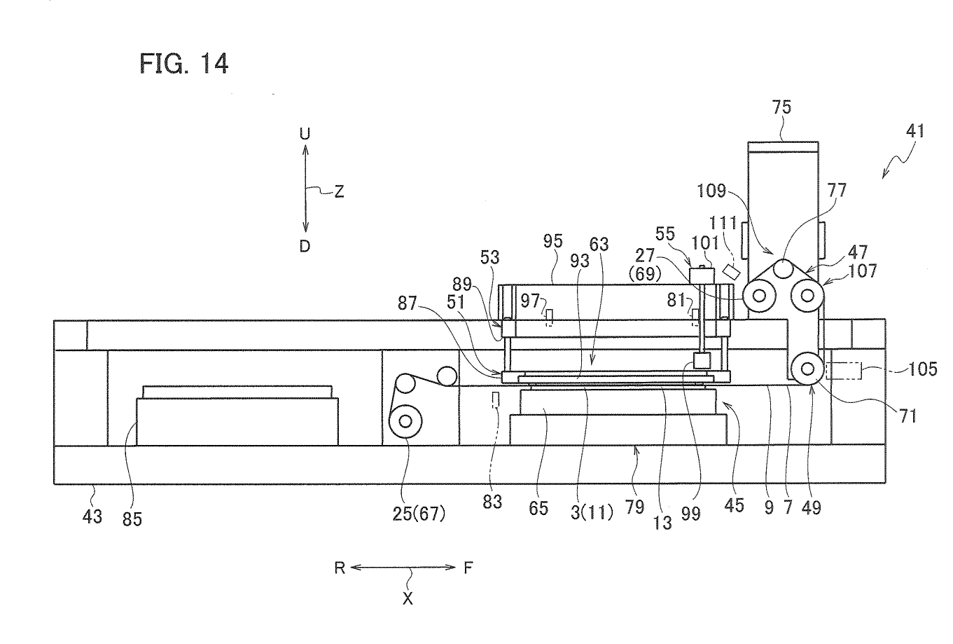

As being moved vertically, the UV generator 99 may travel from an upper position as shown in FIGS. 6, 11 and 12 to a lower position as shown in FIGS. 13 and 14.

The generator support 101 is supported by the carrier 95 in a way as to he movable in the direction along the X-axis. The carrier 95 may have a linear motor or such driving means to move the generator support 101 relative to the carrier 95.

As being moved horizontally, the generator support 101 (or the UV generator 99) may travel from a rear position as shown in FIG. 13 to a front position as shown in FIG. 14 in a controlled speed.

Next, actions of the imprinting device 41 will be described hereafter.

initially, as shown in FIG. 6, the mask unit 13 is laid on the mask bed 85, the supports 89 are lifted up, the carrier 95 is rested at the waiting position, the UV generator 99 is lifted at the upper position, the generator support 101 rests at the rear position, the impression roller 71 is located at the first position, and the substrate 3 with the uncured resin 11 laid thereon is laid on the pedestal 65.

As moving from the initial state as described above, the substrate/mold alignment section 63 operates to align the substrate 3 with the mold 7 and the mask catcher 87 moves down to catch the mask unit 13 and thereafter moves up.

Subsequently, the impression roller 71 moves from the first position to the second position so as to press the mold 7 with the pattern 9 onto the uncured resin 11 on the substrate 3 as shown in FIG. 11.

Subsequently, with keeping mold 7 pressed onto the substrate 3, the carrier 95 moves to the workable position and the mask locater 53 align the supports 89, or the mask unit 13, with the substrate 3 or the mold 7 as shown in FIG. 12.

Subsequently, the mask catcher 87 moves down until the mask unit 13 gets in contact with the mold 7 as shown in FIG. 13.

Alternatively, the process as described above may be modified into a process in which the mask catcher 87 moves down until the mask unit 13 comes close to but slightly apart from the mold 7, then the alignment by the mask locater 53 is executed, and thereafter the mask catcher further moves down to render the mask unit 13 in contact with the mold 7.

Subsequently, the UV generator 99 moves down as shown in FIG. 13 and starts generating ultraviolet ray. With keeping UV generation, the generator support 101 moves from the rear position to the front position to apply the ultraviolet ray to the resin 11 on the substrate 3 through the window 93 of the mask catcher 87, the window section 15 of the mask unit 13, and the mold 7, as shown in FIG. 14.

Thereafter, the UV generator 99 moves up, the generator support 101 moves from the front position to the rear position, the mask catcher 87 moves up, and the carrier 95 moves back to the waiting position.

Subsequently, the impression roller 71 moves from the second position to the first position so as to detach the mold 7 from the substrate 3. Then the process produces the product 1 with the cured resin having a pattern as a mirror-image of the pattern 9 on the mold 7. The conveyor or robot for carrying the substrate 3 is thereafter used to carry out the product 1 and carry in a new substrate 3 to the device 41 and then next imprinting will be executed.

The imprinting device 41 enables accurate formation of the pattern on the product 1 as shown in FIG. 2A because alignment of the mask unit 13 with the substrate 3 or the mold 7 is executed with keeping the mold 7 pressed onto the substrate 3 and consequently the pattern 9 on the mold 7 is accurately positioned relative to the substrate 3.

Specifically, misalignment as illustrated in FIG. 2B, 2C or 2D can be successfully prevented.

In accordance with the imprinting device 41, as the window section 15 of the mask unit 13 is disposed within the range where the pattern 9 is formed on the mold 7 when the mask unit 13 is set in the aligned state, the pattern 9 on the mold 7 is pressed onto the whole part of the uncured resin 11 on the substrate 3 exposed to the ultraviolet ray. Thus, if the mask unit 13 is slightly displaced relative to the substrate 3 or the mold 7 when the mask unit 13 with the window section 15 is aligned with the substrate 3 or the mold 7, the pattern 9 on the mold 7 can be imprinted onto the whole part of the uncured resin 11 on the substrate 3 exposed to the ultraviolet ray.

Further, in accordance with the imprinting device 41, the substrate 3 is aligned with the mold 7 before the mold 7 is pressed onto the substrate 3, the relative position of the mirror-image pattern imprinted on the resin 11 can be made accurate.

Further, in the imprinting device 41, if the shape of the window section 15 of the mask unit 13 is made to be consistent with the shape of the pattern 9 on the mold 7 and the position of the window section 15 of the mask unit is made to be consistent with the position of the pattern 9 on the mold 7 by means of alignment by the mask unit, as explained already with reference to FIGS. 17 and 18, the pattern 9 on the mold 7 can be successfully transferred to the resin 11 without forming the residual portions 21.

Meanwhile, in the imprinting device 41, the substrate bed 45 may be so structured as to make the substrate 3 laid on the substrate bed 45 be capable of moving and aligning with the mold 7 set in the mold holder 47 or the base body 43 in horizontal directions in order to enable imprinting as illustrated in FIG. 19 or 20.

The controller 57 may be so configured as to execute the following control on the mold imprinter 49, the mask locater 53, the UV applicator 55 and the substrate bed 45 in a state where the substrate 3 is laid on the substrate bed 45, the mold 7 is set in the mold holder 47, and the mask unit 13 is supported by the mask support 51.

The controller 57 controls the mold imprinter 49 to press the mold 7 onto the substrate 3, controls the mask locater 53 to align the mask unit 13 with the substrate 3 and the mold 7, and thereafter controls the UV applicator 55 to apply ultraviolet ray to the uncured resin 11 on the substrate 3 laid on the substrate bed 45. The controller 57 reciprocates these controls with changing the substrate 3 relative to the mold 7 and the base body 43 so that all the patterns are imprinted onto the resin 11 on the substrate 3.

Consequently, as shown in FIG. 19 or 20, the single substrate 3 has a plurality of patterns (protrusions 5). This improves efficiency of imprinting on the resin 11 on the substrate 3. The substrate 3 shown in either FIG. 19 or 20 could be divided into a plurality of products 1 as shown in FIG. 1 or such.

The imprinting device 41 may be provided with a recovery device 105 shown by two-dotted chain lines in FIG. 6. The recovery device 105 may have a vacuum device that, by vacuum for example, sucks uncured resin left on the mold 7 when the roller 71 moves to the second position to detach the mold 7 from the substrate 3 after imprinting.

The recovery device 105 may be supported by or united with the roller support 75 so that the recovery device 105 moves along with the impression roller 71.

Further descriptions about the imprinting device 41 will be given hereafter.

The imprinting device 41 could unwind a roll of the elongated. flat sheet-like mold 7 having the pattern 9 formed thereon to extend a part of the mold 7 in a flat state and impress this flat part onto the substrate 3 with the uncured resin 11 in a thin film state thereon, thereby forming the mirror-image pattern of the pattern 9 on the resin 11 on the substrate 3. The imprinting device 41 is provided with the dancer roller 77 and the impression roller 71.

The impression roller 71 is so structured that the mold 7 is threaded therearound and is movable along with the threaded mold 7 between the first position and the second position relative to the base body 43.

The dancer roller 77 is, above the impression roller for example, supported by the roller support 75 and rotatable about a shaft elongated in the Y-axis from the roller support 75.

The mold 7 drawn out of the stock roll 25 set on the feeder 67 is threaded toward the payout roll 27 set on the winder 69 and, halfway in this path, goes around the dancer roller 77.

The dancer roller 77 is, in the direction along the X-axis for example, movable between the third position relatively close to the substrate 3, as shown in FIG. 6, and the fourth position relatively away from the substrate 3, as shown in FIG. 11.

The imprinting device 41 is further provided with an actuator 109, which drives the dancer roller 77 between the third position and the fourth position, and another actuator 107, which moves the impression roller 71 between the first position and the second position.

When the mold 7 is threaded around the impression. roller 71, the impression roller 71 at the first position does not impress the mold 7 onto the substrate 3 but, as slightly advancing toward the second position, starts impressing the mold 7 onto the substrate 3 at one end. (rear end) thereof. As the impression roller 71 advances toward the second position, contact area where the mold 7 is impressed onto the substrate 3 expands toward another end (front end) of the substrate 3, as shown in FIG. 15.

As the impression roller 71 is rotatable about its axis, the impression roller 71 prevents the mold 7 from slipping thereon as it moves from the first position to the second position. The impression roller 71 may be provided with a motor for rotating itself in synchronous with the linear motion to prevent slippage on the mold 7.

The actuator 109 is so configured as to move the dancer roller 77 between the third position and the fourth position.

The dancer roller 77 is also rotatable about its axis. Thus the dancer roller 77 prevents the mold 7 from slipping thereon as it moves between the third position and the fourth position. The dancer roller 77 may be also provided with a motor for rotating itself in synchronous with the linear motion so as to prevent slippage on the mold 7.

The controller 57 controls the actuator 107 to move the impression roller 71 from the first position to the second position so as to impress the mold 7 onto the substrate 3 and, in synchronous therewith, controls the actuator 109 to move the dancer roller 77 from the fourth position to the third position so as to prevent the mold 7 from loosening.

In addition or alternatively, a repulsive body such as a coil spring may be applied to the actuator 109 to urge the dancer roller 77 toward the fourth position. The repulsive force by the repulsive body can naturally prevent loosening as it keeps applying proper tension to the mold 7 in accordance with motion of the impression roller 71.

The controller 57 in addition executes the following control on the actuators 107, 109.

The controller 57 controls the actuator 107 to move the impression roller 71 from the second position to the first position so as to detach the mold 7 from the substrate 3 and, in synchronous therewith, controls the actuator 109 to move the dancer roller 77 from the third position to the second position so as to prevent the mold 7 from loosening.

The controller 57 reciprocates the aforementioned set of the impression control and the detaching control.

The imprinting device 41 may be provided with another UV applicator 111 separate from the DV applicator 55. The UV applicator 111 can be used to apply ultraviolet ray to the mold 7 after exposure to ultraviolet ray by the DV applicator 55. This has efficacy for curing uncured resin transferred from the substrate 3 and thereby preventing the transferred resin from trickling down.

The UV applicator 111 may be supported by or united with the roller support 75 so that the UV applicator 111 moves along with the roller support 75, The UV applicator 111 is so disposed as to apply the ultraviolet ray to the mold 7 just before being wound by the winder 69.

The imprinting device 41 may be operated in the following way.

When the mold imprinter 49 starts imprinting the mold 7 onto the substrate 3, as shown in FIG. 6, the impression roller 71 stays at the first position, the dancer roller 77 stays at the fourth position, and. brakes are put on the stock roll 25 and the payout roll 27 to stop rotation.

The mold imprinter 49 may still put brakes on the stock roll 25 and the payout roll 27 even when imprinting is in progress. The length of the mold 7 drawn out of the rolls 25, 27 is thereby kept constant.

The mold imprinter 49 moves the impression roller 71 from the first position to the second position at a constant speed when imprinting is in progress, and the dancer roller 77 moves down from the fourth position to the third position so as to compensate the length of the mold 7 taken by the impression roller 71, thereby preventing loosening.

When the imprinting is finished, the dancer roller 77 reaches the third position as shown in FIGS. 11 and 14.

When the mold imprinter 49 next moves the impression roller 71 from the second positon as shown in FIGS. 11 and 14 to the first position at a constant speed to detach the mold 7 from the substrate 3, the dancer roller 77 moves up from the third position to the fourth position so as to prevent the mold 7 from loosening.

The aforementioned set of motions of the rollers 71, 77 is reciprocated with keeping the stock roll 25 and the payout roll 27 anti-rotated so as to imprint the pattern onto a plurality of substrates 3 with resin 11.

After executing reciprocal imprinting onto the plurality of substrates 3 or forming a plurality of patterns on a single substrate 3 as shown in FIG. 19 or 20, any actuator such as a servomotor is operated to rotate the winder 69 so as to wind up the mold 7 to the payout roll 27 without loosening the mold 7 between the stock roll 25 and the payout roll 27.

This winding-up causes the stock roll 25 to feed a new part of the mold 7. The mold imprinter 49 uses the renewed part of the mold 7 to execute imprinting.

While the mold 7 may contain a plurality set of patterns 9, a single set of pattern 9 can be used by repetition in a way as described above. Therefore usage of the mold 7 can be reduced to a considerable extent.

In accordance with the imprinting device 41, the uncured resin remaining on the mold 7 is cured by exposure to ultraviolet ray by the UV generator 99. Therefore uncured resin on the mold 7 wound in the payout roll 27 is prevented from trickling down.

The substrate 3 may be formed of a thermoplastic resin for example and instead the curable resin on the substrate 3 may be omitted. Then the imprinting device 41 may be used to imprint the pattern not onto the curable resin but onto the substrate 3 for itself. In this case, the mask unit 13 and the devices about ultraviolet ray application can be omitted.

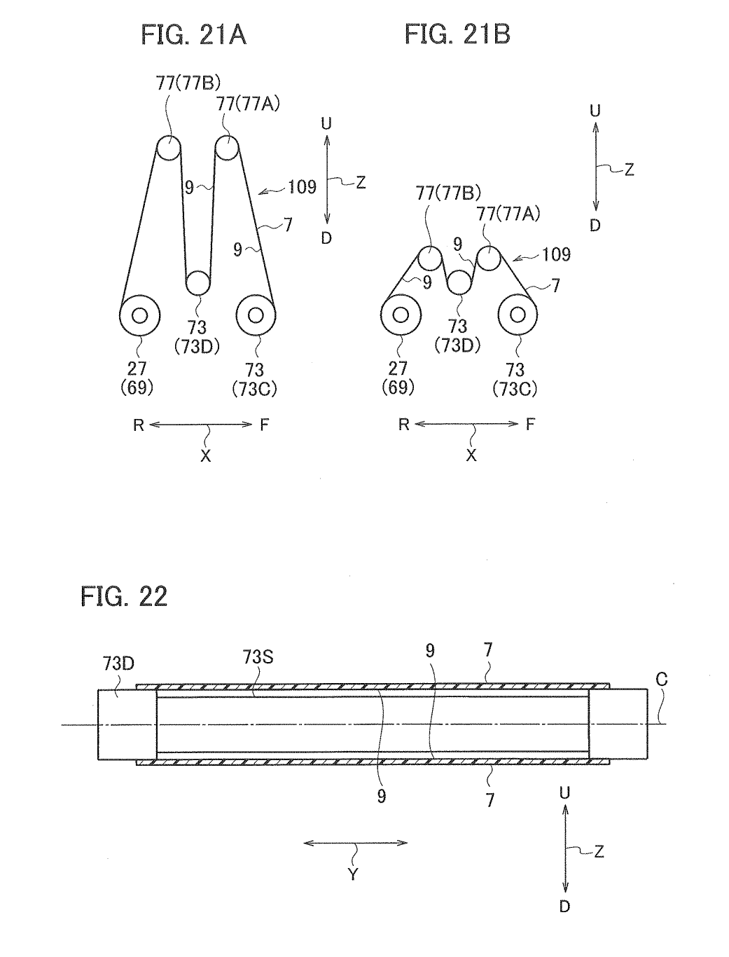

The imprinting device 41 may be provided with two or more dancer rollers 77 as shown in FIGS. 21A and 21B. By moving the dancer rollers 77A, 77B between the fourth position as shown in FIG. 21A and the third position as shown in FIG. 21B, the mold 7 threaded in the rollers can be prevented from loosening. Details will be described below.

The mold 7 drawn out of the stock roll 25 is threaded through the rolls, such as the impression roll 71, and is thereafter threaded around the guiding roller 73C, the dancer roller 77A, the guiding roller 73D and the dancer roller 77B in this order. Finally the mold 7 is wound up by the payout roll 27.

The dancer rollers 77A, 77B may be moved either simultaneously or independently.

The aforementioned structure enables the dancer rollers 77A, 77B to handle a longer length of the mold 7 as compared with a case of the single dancer roller 77. In turn, it enables shorter travel distance of the dancer rollers 77A, 77B to prevent loosening. In sum, this structure enables size reduction of the device as a whole.

The surface of the mold 7, which has the pattern 9, faces outward around the guiding rollers 77A, 77B but is in contact with the guiding roller 73D as shown in FIG. 21. The guiding roller 73D may be formed in a way as shown in FIG. 22, in which the center part 735 is made smaller in diameter than both ends thereof. Such a structure prevents the patterned surface from coming in contact with the guiding roller 73D. In turn, the pattern 9 may be formed on and limited to the surface thus prevented from contact.

The other guiding rollers 73A, 73B and 73C may be formed in the same way.

According to the imprinting device 41 with the dancer roller(s) 77, a method of imprinting may be executed in a way as described hereafter.

The method generally includes a step of setting an impression roller 71 carrying the mold 7 in motion from the first position to the second position to make the mold 7 come in face-to-face contact with the resin 11 to imprint the pattern 9 onto the resin 11 (an impression step); and a step of moving the dancer roller(s) 77 closer to the substrate 3 in synchronous with the motion of the impression roller 71 from the first position to the second position so as to prevent the mold 7 from loosening (a first dancer roller movement step).

In the impression step, by moving the impression roller from the first position to the second position, the mold 7 is impressed onto the substrate 3.

In the first dancer roller movement step, by moving the dancer roller(s) 77, the mold 7 is prevented from loosening in the course of the impression step.

The method further includes a step of curing the resin 11 (a curing step), in which ultraviolet ray is applied to the resin 11 through the mold 7 pressed on the substrate 3.

The method further includes a step of detaching the mold 7 from the substrate 3 by moving the impression roller from the second position to the first position (a detaching step); and a step of moving the dancer roller(s) 77 away from the substrate 3 in synchronous with the motion of the impression roller 71 from the first position to the second position so as to prevent the mold 7 from loosening (a second dancer roller movement step).

In the detaching step, by moving the impression roller 71 from the second position to the first position, the mold 7 is detached from the substrate 3.

In the second dancer roller movement step, by moving the dancer roller(s) 77, the mold 7 is prevented from loosening in the course of the detaching step.

In the method, the impression step, the first dancer roller movement step, the curing step, the detaching step and the second dancer roller movement step may be reciprocally executed in this order. This enables formation of a plurality of products or formation of patterns on a single substrate 3.

The method may further includes a step of additional exposure in which the uncured resin remaining on the mold is exposed to ultraviolet ray after executing the set of the impression step, the first dancer roller movement step, the curing step, the detaching step and the second dancer roller movement step, or reciprocating a plurality of these sets.

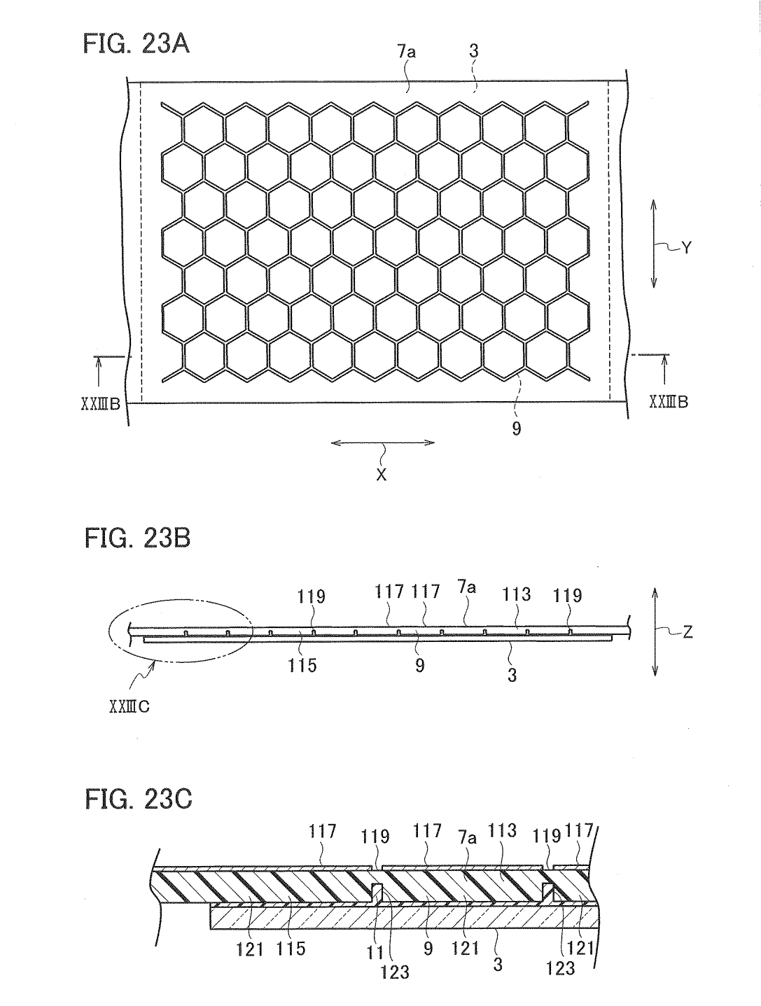

Although the mold 7 is separate from the mask unit 13 in the description above, a mold 7a unitized with a mask unit as shown in FIGS. 23A-23C may be used instead.

The mold 7a unitized with the mask unit is provided with a main section 113, a pattern 115 and shield sections 117 that cut off electromagnetic-wave such as ultraviolet ray. Aside from the shield sections 117, the mold 7a may be structured as with the mold 7 as described above.

Specifically, the main section 113 is generally an elongated flat sheet, or an elongated tape or hand, and the pattern 115 is formed at least on its one surface. The pattern 115 is comprised of a plurality of protrusions 121 and grooves 123 among the protrusions 121.

The shield sections 117 are formed on another surface opposed to the surface containing the pattern 115. The shield sections 117 are so formed on the main section 113 as to be, viewed in its thickness direction, consistent with the protrusions 121, and are formed of a proper material to cut off electromagnetic-wave such as ultraviolet ray.

Meanwhile, all the sections aside from the shield. section 117 are transparent sections 119 that allow the electromagnetic-wave to pass therethrough.

The shield sections 117 may be formed on the mold 7a either in advance or after setting the mold 7a in the imprinting device 41. In the latter case, the imprinting device 41 may be further provided with a shield former such as an ink jet printer.

By using the mold 7a, the mask unit may be omitted although the imprinting device 41 still enables accurate imprinting.

The mold 7a as described above allows formation of the shield sections 117 after formation of the pattern 115 by using an ink jet printer, which can be readily built in the imprinting device 41, as the shielding sections 117 can be formed as thin layers on the surface opposed to the pattern 115.

When in use of the mold 7a, the method of imprinting may be executed in the following way.

The method generally includes a resin-placing step, an impression step, and an exposure step.

In the resin-placing step, uncured resin is placed on the substrate 3 to form a thin layer.

In the impression step, the mold 7a with the pattern 115 and the shield sections 117 consistent therewith is pressed onto the substrate 3.

In the exposure step, ultraviolet ray is applied to the resin on the substrate 3 through the transparent sections 119 on the mold 7a.

The method may further include an alignment, step, in which the substrate 3 is horizontally aligned with the mold 7a before impressing the mold 7a onto the substrate 3 in the impression step.

The thickness of the curable resin on the substrate 3 may be either constant or inconstant. The inconstant thickness may be given in order to prevent formation of gaps or pores in the resin 11 when the mold 7 is pressed onto the substrate 3.

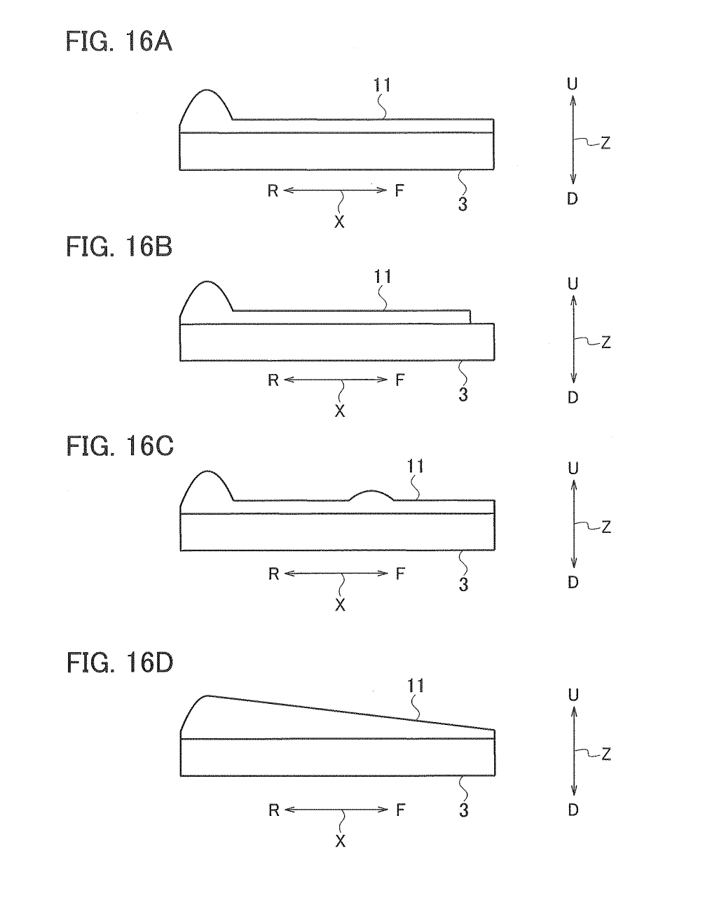

Some examples of the inconstant thickness are illustrated in FIGS. 15A and 16A, in which one end of the resin 11 is made thicker and any other portions are constant in thickness.

Another example is illustrated in FIG. 169, in which one end of the resin 11 is made thicker and another end is short of the corresponding end of the substrate 3. Still another example is illustrated in FIG. 16C, in which one end of the resin 11 is made thicker and the resin 11 further contains a thicker part. Yet another example is illustrated in FIG. 169, in which the resin 11 has a thickness gradient gradually decreasing the thickness in a direction where the impression roller 71 moves.

The curable resin 11 may have a thickness gradient in the lateral direction (along the Y-axis). For example, the resin 11 may be made thicker around the center in the lateral direction and thinner around both lateral edges. The thickness change may be either gradual or stepwise.

If the resin 11 is thicker around one end where imprinting starts, the impression roller 71 pressed thereon squeezes out excessive resin toward another end as it moves from the first position to the second position.

Then as the impression roller 71 moves from the first position to the second position, excess of the resin is dissolved and as well the gaps or pores in the resin can be dissolved because the squeezed resin fills the gaps or pores.

The thickness gradient may prevent the resin sticking out of the substrate 3 as the amount of the resin can be properly regulated.

The resin 11 being thicker around the center in the lateral direction and thinner around both lateral edges can further effectively prevent formation of the gaps or pores in the resin.

In place of the mold, the impression roller 71 of itself may be provided with a pattern to imprint the pattern onto the resin 11 on the substrate 3.

When in use of the impression roller with the pattern, the method of imprinting may be executed in the following way.

The method generally includes a resin-placing step and an impression step.

In the resin-placing step, uncured resin is placed on the substrate 3 to form a thin layer.

In the impression step, the impression roller with the pattern is pressed onto the substrate 3 and moves from one end to another end of the substrate 3, thereby imprinting the pattern on the resin. Also in this case, the resin may have a thickness gradient as described above.

Although certain exemplary embodiments have been described above, modifications and variations of the embodiments described above will occur to those skilled in the art, in light of the above teachings.

What is claimed is:

1. A device for feeding a sheet-like mold with a pattern of unevenness from a feeder to a winder and imprinting the pattern onto a resin laid on a substrate, comprising:
an impression roller carrying the mold and being movable in parallel with a surface of the substrate between. a first position and a second position apart from the first position and so disposed as to impress the mold onto the substrate in response to a movement from the first position to the second position;
a dancer roller guiding the mold toward the winder and being movable between a third position and a fourth position, the third position and the fourth position being respectively close to and away from the substrate in a direction perpendicular to the surface of the substrate;
a first driver configured to drive the impression roller between the first position and the second position;
a second driver configured to drive the dancer roller between the third position and the fourth position; and
a controller electrically connected to and configured to control the first driver and the second driver, the controller being configured execute a first control of the first driver to set the impression roller in motion from the first position to the second position to imprint the pattern onto the resin and of the second driver to move the dancer roller from the fourth position toward the third position in synchronous with the motion of the impression roller from the first position to the second position so as to prevent the mold from loosening.

2. The device of claim 1, wherein the controller configured to execute a second control of the first driver to set the impression roller in motion from the second position to the first position so as to detach the mold from the substrate and of the second driver to move the dancer roller from the third position to the fourth position in synchronous with the motion of the impression roller from the second position to the first position so as to prevent the mold from loosening.

3. The device of claim 2, wherein the controller is configured to reciprocate the first control and the second control.

4. The device of claim 3, further comprising:
an electromagnetic-wave applicator configured to apply an electromagnetic wave to the resin,
wherein the resin is viscous but curable when exposed to the electromagnetic wave, and
wherein the controller is configured to operate the electromagnetic-wave applicator to apply the electromagnetic wave to the resin being impressed with and detached from the mold.

5. The device of claim 1, further comprising:
one or more dancer rollers aside from the dancer roller as recited in claim 1.

6. A method for feeding a sheet-like mold with a pattern of unevenness from a feeder to a winder and imprinting the pattern onto a resin laid on a substrate, comprising:
setting an impression roller carrying the mold in motion in parallel with a surface of the substrate from a first position to a second position apart from the first position so as to impress the mold onto the substrate in response to the motion; and
moving a dancer roller for guiding the mold to the winder closer to the substrate in synchronous with the motion of the impression roller from the first position to the second position so as to prevent the mold from loosening.

7. The method of claim 6, further comprising:
detaching the mold from the substrate by moving the impression roller from the second position to the first position.

8. The method of claim 7, further comprising:
reciprocating the step of setting the impression roller in the motion from the first position to the second position and the step of detaching the mold from the substrate so as to imprint the pattern onto distinct plural areas of the resin.

9. The method of claim 7, further comprising:
applying an electromagnetic wave to the resin being molded by and detached from the mold after executing the step of reciprocating, wherein the resin is viscous but curable when exposed to the electromagnetic wave.
